(19) United States
(12) Patent Application Publication
(10) Pub. No.: US 2004/0260215 A1
(43) Pub. Date: Dec. 23, 2004

(54) Human body massaging method and apparatus

(76) Inventor: Hakjin Kim, Diamond Bar, CA (US)

Correspondence Address: PARK & SUTTON LLP, 3255 WILSHIRE BLVD, SUITE 1110, LOS ANGELES, CA, 90010, US

(21) Appl. No.: 10/602,098

(22) Filed: Jun. 23, 2003

(51) Int. Cl. A61H 15/00

(52) U.S. Cl. 601/99; 601/100; 601/103; 601/116

(57) ABSTRACT

A method and an apparatus for three dimensional, accurately controllable and user customizable massaging are provided. The apparatus includes actuators for three-axis movement of massage bumps, a pressure sensor and a temperature sensor. Pre-configured massaging curves which are followed by the massage bumps are provided and a user may select and further customize the curves. Also the curve may be adjusted by measuring the body contour of a user and incorporating the measured curve into existing curves. The massaging curve includes acupressure operations and heat treatment operations.

### BACKGROUND OF THE INVENTION

The invention relates generally to a method and an apparatus for human body massaging. More particularly, the present invention relates to an improved method and apparatus capable of efficiently treating bodily malfunctions such as pains related to the backbone and muscles in vicinity of the backbone, blood circulation troubles, and gastrointestinal weakness, etc. by providing acupressure movement and heat treatment to relevant points of a human body.

Conventional bed or mat type massage devices provide basic reciprocating motions of massage bumps, which apply pressure on the body of a patient, along the body. The massage devices of prior art have a disadvantage that it cannot provide massaging that considers detailed curvatures of various patients. Each human being has a different height, weight and body surface curvature. However, massage devices of prior art provide a simple linear massage motion or modified by a simple jig that resembles the curve of a human backbone. Springs, cushions or links were used to accommodate the deviations from the simple reciprocating massage motion. However, such means did not effectively provide therapeutic massage effect, or acupressure. Further, due to rough massaging motions of massage bumps, which do not accommodate precise human body shapes, pains were induced to the user of the massage devices.

Also, there are medically important points on the human body, on which heating and acupressure treatment should be concentrated. While the positions of the points and intensity of treatments are different from patient to patient, conventional massage devices did not provide customized massaging motion that is controllable to meet such requirements.

A massage method and a massage apparatus providing accurate massaging movement for effective massage and acupressure treatment have been in demand for a long time.

### SUMMARY OF THE INVENTION

The present invention is contrived to overcome the conventional disadvantages. Accordingly, an object of the invention is to provide a method and an apparatus for massaging human body that can provide massaging motion adapted to different height and width of individual human bodies.

Another object is to provide a method and an apparatus for massaging human body that can provide three-dimensional massaging motions.

Still another object is to provide a method and an apparatus for massaging human body in which a user can adjust or customize details of massaging motions.

Still another object is to provide a method and an apparatus for massaging human body in which the body contour of a user is measured and memorized in order to provide most effectively customized massaging motion.

To achieve these and other objects, the invention provides a method for massaging the body of a patient, who is resting on a upper surface portion of a platform. The upper surface portion includes a first end and a second end. The method includes a step of moving a pressure applying member between the first end and the second end for a predetermined longitudinal stroke. The step of moving the pressure applying member includes moving the pressure applying member forward from the first end to the second end, moving the pressure applying member backward from the second end to the first end, and repeating the forward moving step and the backward moving step. The movement of the pressure applying member follows a predetermined height curve in a plane defined by a first axis that is parallel to the upper surface portion and longitudinal to the platform and a second axis that is perpendicular to the first axis and to the upper surface portion. The first axis coordinate of the height curve is defined by a first function of time, and the second axis coordinate of the height curve is defined by a second function of the first axis coordinate.

The height curve follows the backside contour of the patient. The height curve may include a plurality of square curves or convex portions at predetermined first axis coordinates. Square waves or convex portions provide acupressure effects.

The square wave or convex portion of the pressure applying member movement may be repeated for a predetermined number of times.

The starting point of each of the square waves or the convex portions may be shifted for a predetermined distance along the first axis.

The height curve is divided into a plurality of discrete sections, and the pressure applying member applies pressure to the patient for selected discrete sections.

In the backward movement of the pressure applying member, the second axis coordinate of the height curve may have a constant value, which is sufficiently small so that the pressure applying member does not apply pressure to the patient.

During the step of moving the pressure applying member, the movement of the pressure applying member in the second axis direction is stopped when the pressure applied by the pressure applying member reaches a massage pressure threshold. And the massage pressure threshold is adjustable.

Also, the reference point of the second axis coordinate of the height curve is adjustable whereby the pressure applied by the pressure applying member is adjustable.

The longitudinal stroke is adjustable for a different height of the patient, and the height curve is adjusted proportional to the adjusted longitudinal stroke.

The method further includes a step of measuring body contour before the step of moving the pressure applying member along the height curve. The measuring step includes measuring the second axis coordinate of the pressure applying member while the pressure applying member is moved along the first axis at a constant speed. During the measuring step, the pressure applying member is moved toward the patient in the direction of the second axis until the pressure applied on the patient by the pressure applying member reaches a threshold. A curve formed by the measured second axis coordinates and the corresponding first axis coordinates is memorized. And in the moving step, the height curve includes the memorized curve. The patient can adjust the threshold in the measuring step.

The method further provides movement of width direction of the patient's body. During the step of moving the pressure applying member, the movement of the pressure applying member follows a predetermined width curve in a plane defined by the second axis and a third axis that is perpendicular to the first axis and the second axis. The third axis coordinate of the width curve is defined by a fourth function of the first axis coordinate.

The pressure applying member includes one or more movable massage bumps that protrude toward the patient, and the movement of the massage bumps follow the width curve. The pressure applying member may further include one or more fixed massage bumps. The movable massage bumps are wheels or spheres.

The width curve is a sine wave or has a shape of a two-dimensional coil. The maximum width of the width curve is adjustable.

The massage bumps are positioned symmetrical to the center of the pressure applying member, and the movement of the massage bumps forms two width curves that are parallel to each other.

The movement of the massage bumps follow the same width curve. Alternatively, the width curves followed by two longitudinally adjacent massage bumps among the massage bumps are spaced by the distance between the two longitudinally adjacent massage bumps.

The body contour of the patient in the width direction is measured by measuring the second axis coordinate of the pressure applying member while the pressure applying member is moved along the third axis at a constant speed at a given first axis coordinate. The pressure applying member is moved toward the patient in the direction of the second axis until the pressure applied on the patient by the pressure applying member reaches a threshold. A curve formed by the measured second axis coordinates and the corresponding third axis coordinates is memorized.

The height curve and the width curve together form a massage surface which the pressure applying member follows.

The width curve basically follows the body contour of the patient.

For initial predetermined number of cycles of the forward and backward moving steps, the height curve is the curve following the backside contour of the patient, and then the height curve includes acupressure sections. The acupressure sections include linear acupressure movement, or convex acupressure movement or both. The patient can add or remove acupressure sections along the first axis.

The invention also provides an apparatus for massaging the body of a patient, who is resting on a upper surface portion of a platform. The upper surface portion comprises a first end and a second end. The apparatus includes a pressure applying member that is movable between the first end and the second end for a predetermined longitudinal stroke along a first axis that is parallel to the upper surface portion and longitudinal to the platform and a second axis that is perpendicular to the first axis and to the upper surface portion, a first axis controller that controls movement of the pressure applying member along the first axis, and a second axis controller that controls movement of the pressure applying member along the second axis. The movement of the pressure applying member follows a predetermined height curve in a plane defined by the first axis and the second axis. The first axis coordinate of the height curve is defined by a first function of time, and the second axis coordinate of the height curve is defined by a second function of the first axis coordinate.

The apparatus further includes a microprocessor that is connected to the first axis controller and the second axis controller. The microprocessor stores a plurality of height curves, and the first axis controller and the second axis controller control the movement of the pressure applying member following the height curve selected by the patient. A remote controller is connected to the microprocessor for use by the patient.

The first axis controller includes a first axis actuator and a first axis displacement sensor. The first axis actuator moves the pressure applying member along the first axis, and the first axis displacement sensor measures the displacement of the pressure applying member along the first axis. The second axis controller includes a second axis actuator and a second axis displacement sensor. The second axis actuator moves the pressure applying member along the second axis, and the second axis displacement sensor measures the displacement of the pressure applying member along the second axis.

The second axis controller further includes a pressure sensor, which measures the pressure applied to the patient by the pressure applying member.

The platform includes an upper platform and a lower platform. The upper platform supports the upper body of the patient, and the lower platform supports the lower body of the patient. The upper platform may be inclined to make an angle with a horizontal surface, and the angle is adjustable.

The pressure applying member has a heating member, wherein the temperature of the heating member is controlled as a third function of the first axis coordinate in the moving step.

The apparatus further includes a third axis controller that controls movement of the pressure applying member along a third axis. The third axis is perpendicular to the first axis and the second axis. The movement of the pressure applying member follows a predetermined width curve in a plane defined by the second axis and the third axis. The third axis coordinate of the width curve is defined by a fifth function of the first axis coordinate.

The microprocessor is connected to the third axis controller. The microprocessor stores a plurality of width curves,.and the first axis controller and the third axis controller control the movement of the pressure applying member following the width curve selected by the patient.

The third axis controller includes a third axis actuator and a third axis displacement sensor. The third axis actuator moves the pressure applying member along the third axis, and the third axis displacement sensor measures the displacement of the pressure applying member along the third axis.

The third axis controller further comprises a temperature sensor, wherein the temperature sensor measures the temperature of the pressure applying member.

The body contour of the patient in the width direction is measured by measuring the second axis coordinate of the pressure applying member while the pressure applying member is moved along the third axis at a constant speed at a given first axis coordinate. The pressure applying member is moved toward the patient in the direction of the second axis until the pressure applied on the patient by the pressure applying member reaches a threshold. A curve formed by the measured second axis coordinates and the corresponding third axis coordinates is memorized in the microprocessor.

The heat and massage treatment apparatus of the present invention provides automated and controlled cautery and acupressure treatment. The cautery treatment provides heat to the human body. The acupressure treatment provides massaging or regulated pressure to the human body. The treatments are concentrated on energy points and energy paths of the human body.

In the orienatal medical therapy, the energy points (Kyunhyul) and the energy paths (Kyungrak) are important portions of a human body that are related to proper functioning of the internal organs of a human being.

Advantages of the present inventions include that: (1) the method and apparatus of the present invention provides cautery and acupressure treatment for precise positions of the human body; (2) the present invention provides comfortable massage feeling to the user by customizating massaging movements for individual users; (3) the present invention maximizes massaging effect by three-dimensional massaging motion; (4) various pre-configured massaging motions are provided and the motions can be further refined by adapting them to the backside contour of the user and customizing detailed massaging motions for important portions of the user's body; (5) the present invention provides relaxation and energy flow enhancement to the energy points, energy paths and nerves connected to or distributed around the spine; (6) the present invention provides effective treatment in recovering crooked or protruded spines to their original shape, and recovering squeezed or worn cartilages; (7) the present invention provides effective treatment in removing excess fat and cholesterol that are deposited in blood vessels; (8) nerve cells are relaxed therby recovering and expediting functions of internal organs connected to the nerve cells; and (9) the present invention provides continuous, economic and user-friendly cautery and acupressure treatment.

Although the present invention is briefly summarized, the full understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic elevation view showing an apparatus for human body massaging with a patient lying thereon according to the first embodiment of the present invention;

FIG. 2 is a schematic elevation view showing an apparatus for human body massaging with a patient lying thereon according to the second embodiment of the present invention;

FIG. 3 is a view similar to FIG. 2 but shows that a massaging platform is inclined;

FIG. 4 is a schematic perspective view showing the three-dimensional motion of a pressure applying member in the XYZ space;

FIG. 5 is a schematic plan view showing the width and length limits of the pressure applying member movement;

FIG. 6 is a plan view of the pressure applying member having four moving massage bumps;

FIG. 7 is a view similar to FIG. 6 but showing that the massage bumps are moved up to the width limit;

FIG. 8 is a plan view of the pressure applying member having four moving massage bumps and two stationary center massage bumps;

FIG. 9 is a view similar to FIG. 8 but showing that the moving massage bumps are moved up to the width limit;

FIG. 10 is a side elevation view of the pressure applying member;

FIG. 11 is a graph showing a curve that indicates the movement of the pressure applying member in XY plane, and the curve follows the backside contour of a human body;

FIG. 12 is a graph showing a curve that indicates the movement of the pressure applying member in XY plane, and the curve includes square acupressure operations;

FIG. 13 is a graph showing a curve that indicates the movement of the pressure applying member in XY plane, and the curve includes convex acupressure operations;

FIG. 14 is a graph showing a curve that indicates the movement of the pressure applying member in XY plane, and the curve follows the backside contour of a human body and includes square acupressure operations;

FIG. 15 is a graph showing a curve that indicates the movement of the pressure applying member in XY plane, and the curve follows the backside contour of a human body and includes convex acupressure operations;

FIG. 16 is a graph showing a curve that indicates the movement of the pressure applying member in XY plane, and the curve follows the backside contour of a human body and includes square and convex acupressure operations;

FIG. 17 is a graph showing a curve that indicates the movement of the pressure applying member in XY plane, and the curve is divided into a plurality of sections, and acupressure operations are limited to specific sections;

FIG. 18 is a graph showing a curve that indicates temperature variation of the pressure applying member along the X axis;

FIG. 19 is a graph showing a curve that indicates the movement of the massage bumps of the pressure applying member in XZ plane, and that the curve is a sine wave, and that two massage bumps follow the same curve;

FIG. 20 is a graph showing two curves that indicate the movement of the massage bumps of the pressure applying member in XZ plane, and the curves are sine waves that are parallel to each other;

FIG. 21 is a graph showing a curve that indicates the movement of the massage bumps of the pressure applying member in XZ plane, and the curve has a shape of a two-dimensional coil;

FIG. 22 is a graph showing two curves that indicate the movement of the massage bumps of the pressure applying member in XZ plane, and the curves have a shape of a two-dimensional coil and are parallel to each other;

FIG. 23 is a graph showing a curve that indicates the movement of the massage bumps of the pressure applying member in XYZ space;

FIG. 24 is a graph showing two curves that indicate the movement of the massage bumps of the pressure applying member in XZ plane, and that movement of one of the massage bumps forms a first sine wave and movement of the other of the massage bumps forms a second sine wave that is spaced from the first sine wave by the distance between the two massage bumps;

FIG. 25 is a graph showing four curves that indicate the movement of the massage bumps of the pressure applying member in XZ plane, and that movement of two massage bumps in one side forms two coils that are spaced from each other by the distance between the two massage bumps, and that movement of two massage bumps in the other side also forms two similar coils;

FIG. 26 is a graph showing a curve that indicates the movement of the massage bumps of the pressure applying member in YZ plane, and the curve follows backside contour of a patient;

FIG. 27 is a graph showing a curve that indicates the movement of the pressure applying member in XY plane, and the curve shows that a square acupressure operation may be shifted by a predetermined amount, and a convex square acupressure operation may be shifted by a predetermined amount;

FIG. 28 is a schematic block diagram showing the components of the apparatus for human body massaging;

FIG. 29 is a perspective view showing an embodiment of the apparatus; and

FIG. 30 is a flow chart showing the method for human body massaging.

### DETAILED DESCRIPTION OF THE PREFERRED EMBODIMENTS

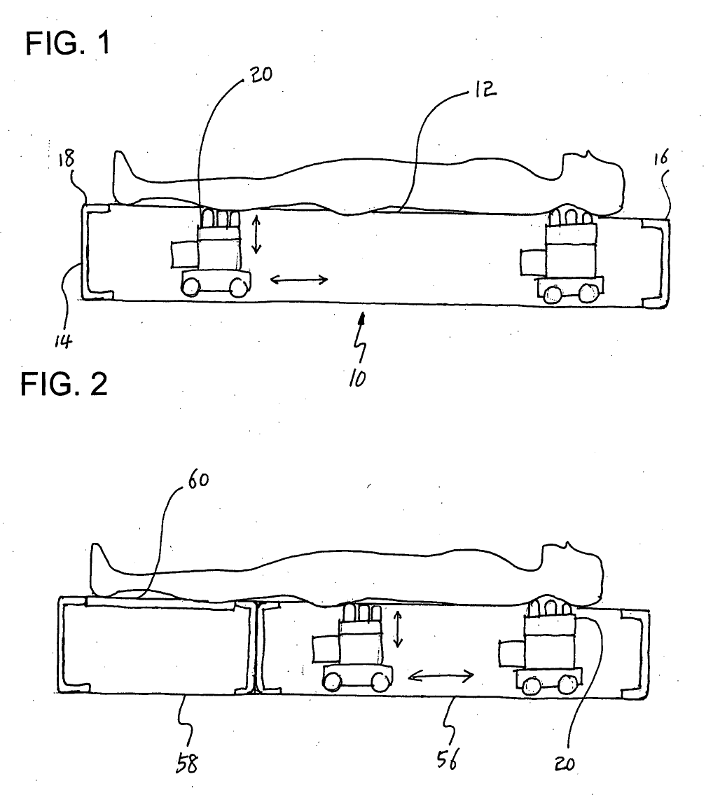

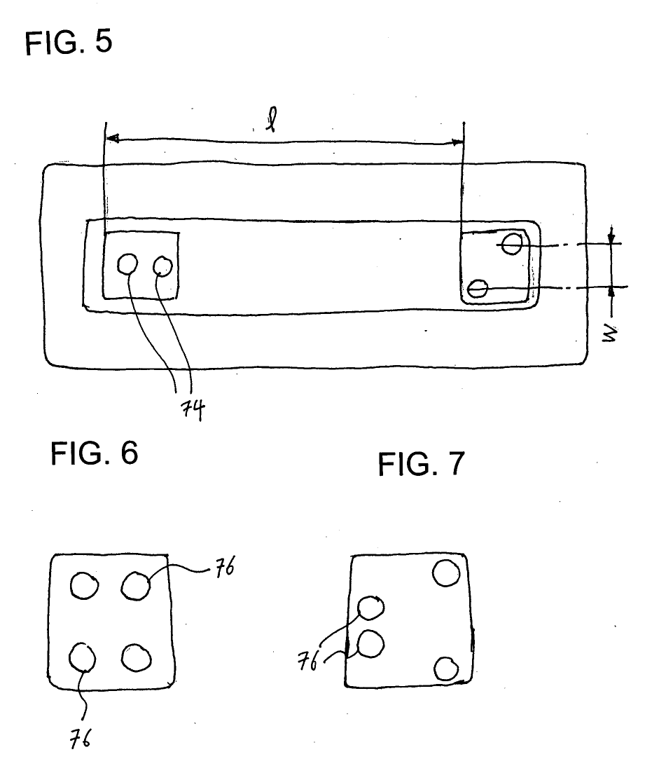

FIG. 1 shows an apparatus 10 for massaging a human body. A patient rests on an upper surface portion 12 of a platform 14. The upper surface portion 12 includes a first end 16 and a second end 18. The apparatus 10 includes a pressure applying member 20 that is movable between the first end 16 and the second end 18 for a predetermined longitudinal stroke 1 (refer to FIG. 5) along a first axis X that is parallel to the upper surface portion 12 and longitudinal to the platform 14 and a second axis Y that is perpendicular to the first axis X and to the upper surface portion 12(refer to FIG. 4). The pressure applying member 20 contacts backside of the patient and applies pressure to the patient.

FIG. 2 shows that the platform 14 includes an upper platform 56 and a lower platform 58. The upper platform 56 supports the upper body of the patient, and the lower platform 58 supports the lower body of the patient.

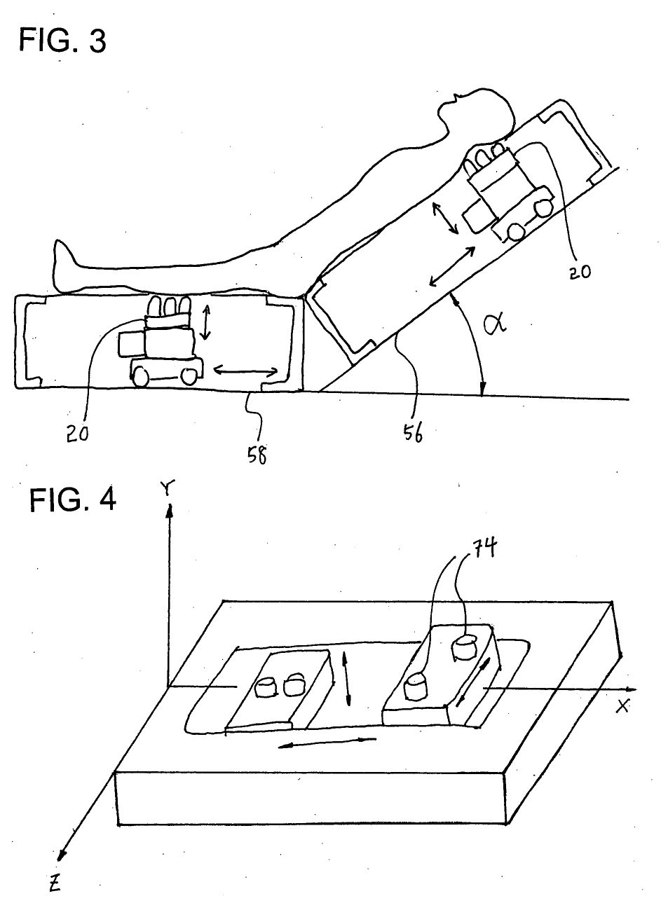

FIG. 3 shows that the upper platform 56 makes an angle α with a horizontal surface. The angle α is adjustable by the patient so that the upper platform 56 may be used like a back plate of a chair. FIG. 3 shows that the pressure applying member 20 is also provided in the lower platform 58. FIG. 2 shows that a heating mat 60 instead of the pressure applying member 20 is provided in the lower platform 58.

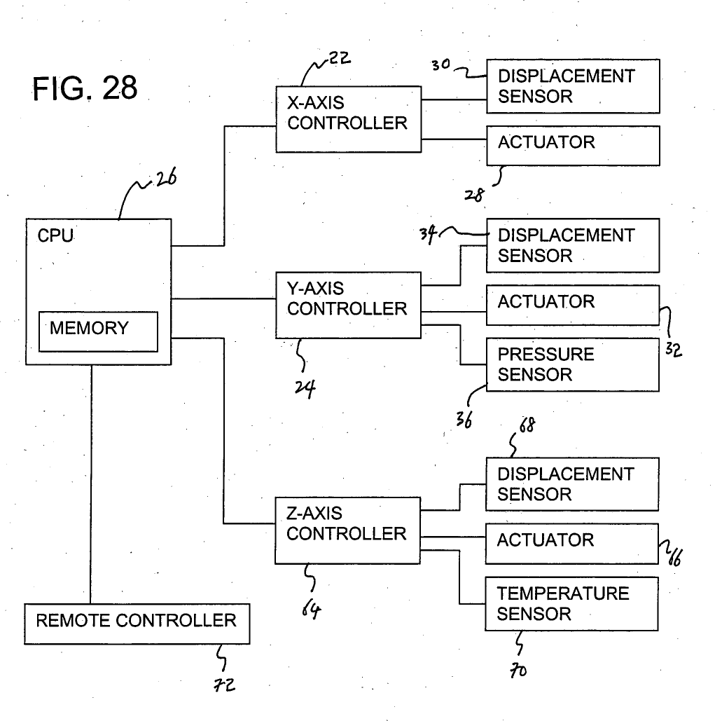

Referring to FIG. 28, the apparatus 10 further includes a first axis controller 22 that controls movement of the pressure applying member 20 along the first axis X, and a second axis controller 24 that controls movement of the pressure applying member 20 along the second axis Y.

The pressure applying member follows a predetermined height curve in the XY plane in FIG. 4. The first axis coordinate of the height curve is defined by a first function of time, and the second axis coordinate of the height curve is defined by a second function of the first axis coordinate. In this way, massaging motion by the pressure applying member 20 may be conveniently defined and controlled with the height curve.

Referring back to FIG. 28, the apparatus 10 further includes a microprocessor 26 that is connected to the first axis controller 22 and the second axis controller 24. The microprocessor 26 stores a plurality of height curves, and the first axis controller 22 and the second axis controller 24 control the movement of the pressure applying member 20 following the height curve selected by the patient.

The first axis controller 22 includes a first axis actuator 28 and a first axis displacement sensor 30. The first axis actuator 28 moves the pressure applying member 20 along the first axis X, and the first axis displacement sensor 30 measures the displacement of the pressure applying member 20 along the first axis X. The second axis controller 24 includes a second axis actuator 32 and a second axis displacement sensor 34. The second axis actuator 32 moves the pressure applying member 20 along the second axis Y, and the second axis displacement sensor 34 measures the displacement of the pressure applying member 20 along the second axis Y. The information provided by the displacement sensors 30, 34 may be used to feedback control the movement of the pressure applying member 20 or to measure the displacement of the pressure applying member 20.

The second axis controller 24 further includes a pressure sensor 36. The pressure sensor 36 measures the pressure applied to the patient by the pressure applying member 20.

During the movement of the pressure applying member 20, the movement of the pressure applying member 20 in the second axis direction is stopped when the pressure applied by the pressure applying member 20 reaches a massage pressure threshold. The massage pressure threshold is adjustable so that massage intensity is controlled.

The body contour of the patient is measured by measuring the second axis coordinate of the pressure applying member 20 while the pressure applying member 20 is moved along the first axis X at a constant speed. The pressure applying member 20 is moved toward the patient in the direction of the second axis Y until the pressure applied on the patient by the pressure applying member 20 reaches a threshold. A curve formed by the measured second axis coordinates and the corresponding first axis coordinates is memorized in the microprocessor 26.

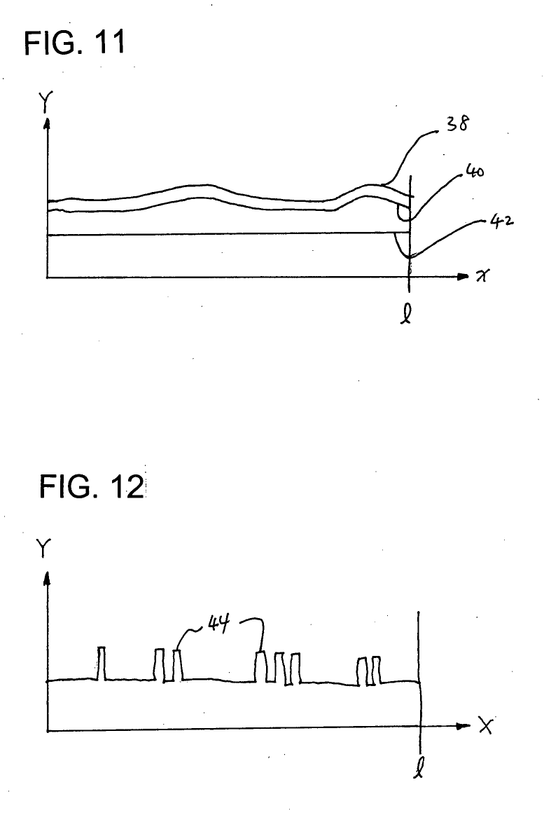

FIGS. 11-17 show various height curves. In FIG. 11, the height curves 38 and 40 follow the backside contour of the patient. The height curve 38, 40 start from 0 on the first axis X, and ends at the longitudinal stroke 1. The height curves 38 and 40 have different starting points or reference points on the second axis Y. The reference point of the second axis Y coordinate of the height curve is adjustable whereby the pressure applied by the pressure applying member 20 is adjustable. The height curve following the body contour is effective in relieving or curing muscular pain after hard exercise, stressed blood vessels, and cold limbs due to retarded blood circulation, etc. Pre-configured height curves are initially stored in the microprocessor 26.

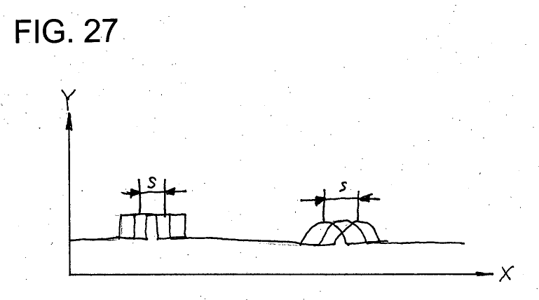

In FIG. 12, the height curve includes a plurality of square curves 44 at predetermined first axis X coordinates. The movement of the pressure applying member 20 along each of the square curves 44 may be repeated for a predetermined number of times. That is, acupressure operation by the square curve can be repeated for a certain points of the patient body. Also, as shown in FIG. 27, the starting point of each of the square waves may shift along the first axis X for a predetermined amount s. The height curve including the square waves together with heat treatment by the heater 62 are effective in detailed and localized massaging for the blood vessels, nerves, energy points and energy paths around the backbone. The height of the square wave is about 30 mm.

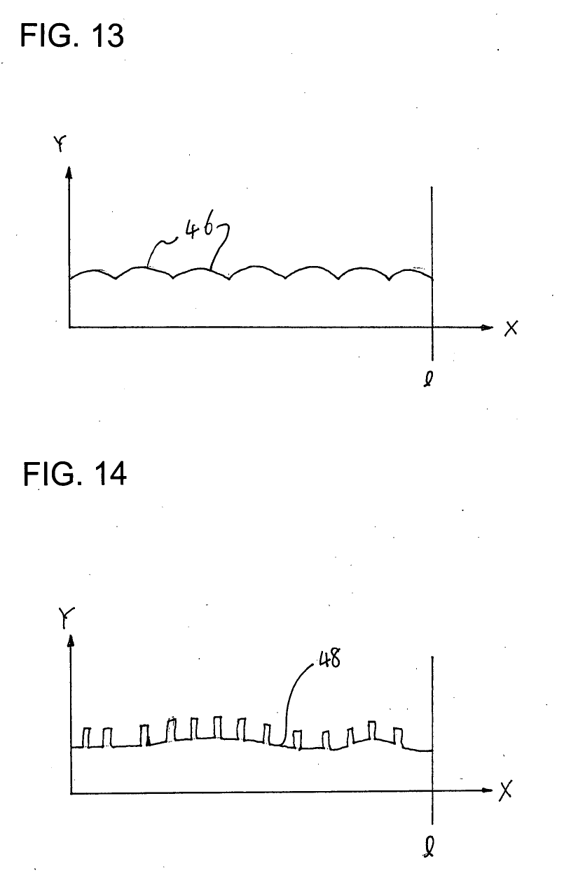

In FIG. 13, the height curve includes a plurality of convex portions 46 at predetermined first axis X coordinates. The movement of the pressure applying member 20 along each of the convex portions 46 may be repeated for a predetermined number of times. That is, acupressure operation by the convex portion can be repeated for a certain points of the patient body. Also, as shown in FIG. 27, the starting point of each of the convex portion may shift along the first axis X for a predetermined amount s. The height curve including convex portions provides soft and flexible movement of the backbone. The height of the convex portion is about 10 mm.

FIG. 14 shows that the curves shown in FIGS. 11 and 12 are combined. That is, the height curve 48 follows the body contour and includes a plurality of square waves at predetermined first axis X coordinates.

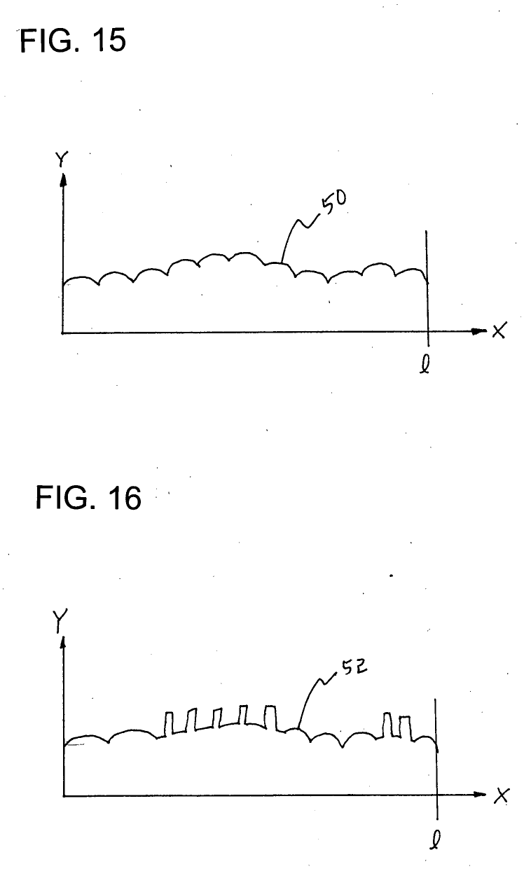

FIG. 15 shows that the curves shown in FIGS. 11 and 13 are combined. That is, the height curve 50 follows the body contour and includes a plurality of convex portions at predetermined first axis X coordinates.

FIG. 16 shows that the curves shown in FIGS. 11-13 are combined. That is, the height curve 52 follows the body contour and includes a plurality of square curves and a plurality of convex portions at predetermined first axis X coordinates. The square curves and convex portions may be pre-configured or added or removed by the patient.

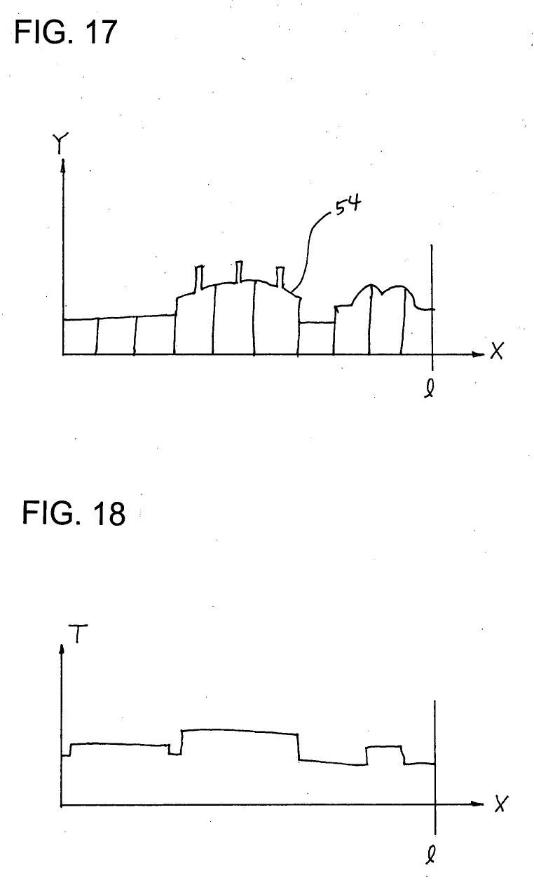

FIG. 17 shows that the height curve is divided into a plurality of discrete sections 54, and the pressure applying member 20 applies pressure to the patient for selected discrete sections. The selected sections may be pre-configured. The patient also add or remove the sections. This sectioning facilitates manual adjustment of the height curves for a particular patient's need.

Referring back to FIG. 11, the second axis Y coordinate of the height curve 42 has a constant value. The constant value is sufficiently small so that the pressure applying member 20 does not apply pressure to the patient. This curve may be used when quickly returning the pressure applying member 20 backward from the second end 18 to the first end 20 of the platform 14 so that massaging is done in one direction rather in both directions.

The longitudinal stroke 1 is adjustable for a different height of the patient. Then the height curve is adjusted proportional to the longitudinal stroke.

The pressure applying member 20 includes a heating member 62 as shown in FIG. 10. The temperature of the heating member 62 is controlled as a third function of the first axis X coordinate when the pressure applying member 20 is moved as shown in FIG. 18.

Referring back to FIG. 28, the apparatus 10 further includes a third axis controller 64 that controls movement of the pressure applying member 20 along the third axis Z in FIG. 4. The third axis Z is perpendicular to the first axis X and the second axis Y. The movement of the pressure applying member follows a predetermined width curve in XZ plane. The third axis Z coordinate of the width curve is defined by a fifth function of the first axis coordinate.

The microprocessor 26 is connected to the third axis controller 64. The microprocessor 26 stores a plurality of width curves, and the first axis controller 22 and the third axis controller 64 control the movement of the pressure applying member 20 following the width curve selected by the patient.

The third axis controller 64 includes a third axis actuator 66 and a third axis displacement sensor 68. The third axis actuator 66 moves the pressure applying member 20 along the third axis Z, and the third axis displacement sensor 68 measures the displacement of the pressure applying member 20 along the third axis Z.

The third axis controller 64 further includes a temperature sensor 70. The temperature sensor 70 measures the temperature of the pressure applying member 20.

A remote controller 72 is connected to the microprocessor 26 so that the patient can adjust the height and width curves and other operations of the apparatus 10.

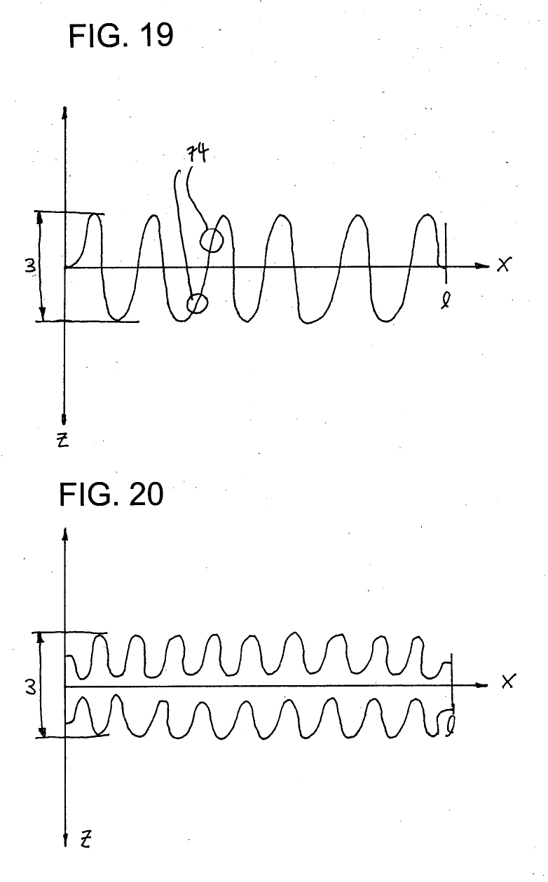

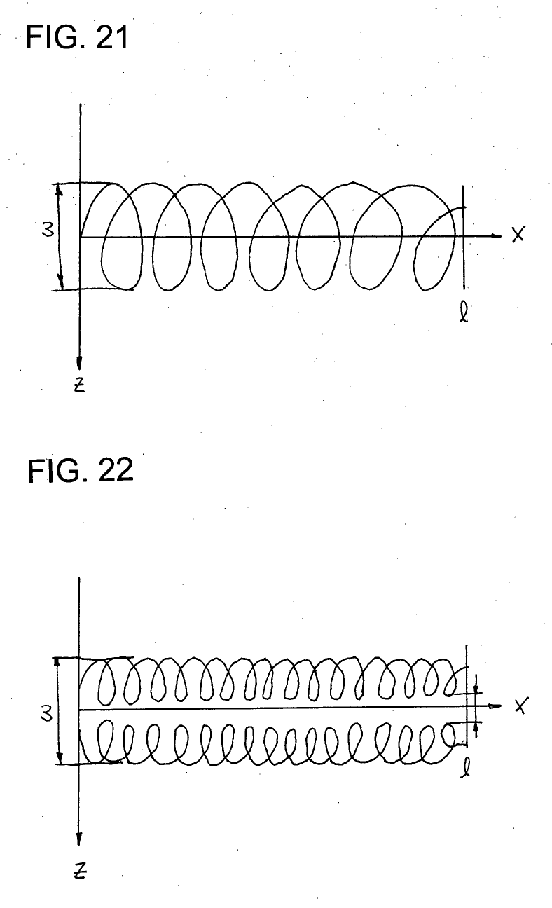

FIGS. 19-25 show various width curves. In FIG. 19, the width curve is a sine wave. In FIG. 21, the width curve has a shape of a two-dimensional coil. FIG. 19 also shows that the maximum width of the width curve is the width w in FIG. 4. The width w is adjustable to accommodate varying widths of patient bodies.

The pressure applying member 20 includes one or more movable massage bumps that protrude toward the patient, and the movement of the massage bumps follow the predetermined width curve. In FIGS. 4 and 5, two movable massage bumps 74 are provided. In FIGS. 6 and 7, four movable massage bumps 76 are provided.

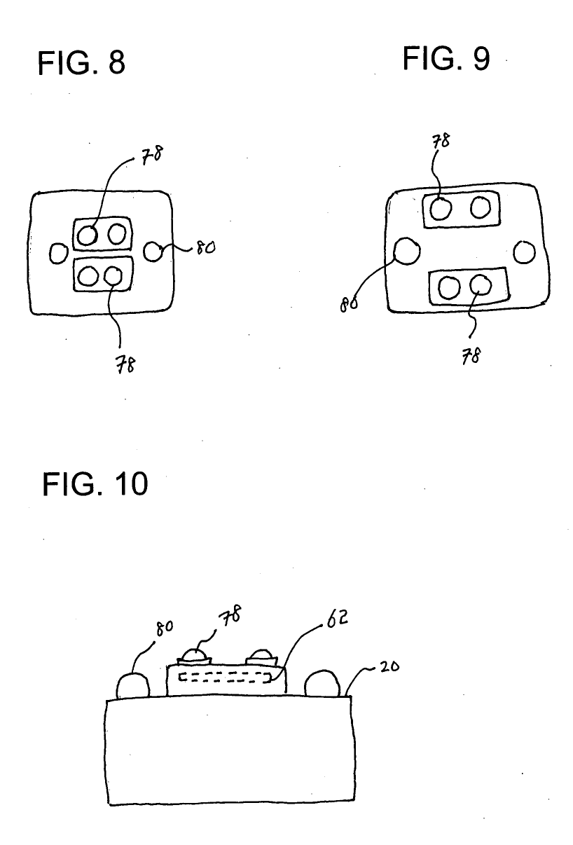

The pressure applying member 20 may further include one or more fixed massage bumps. In FIGS. 8-10, four movable massage bumps 78 and two fixed massage bumps 80 are provided. The movable massage bumps 78 are move in pairs, and the fixed massage bumps 80 are lower than the movable massage bumps 78 as shown in FIG. 10. The movable massage bumps 78 are positioned symmetrical to the center of the pressure applying member 20, and the movement of the massage bumps 78 forms two width curves that are parallel to each other. FIG. 20 shows that the two width curves are sine waves, and FIG. 22 shows that the two width curves have a shape of a two-dimensional coil.

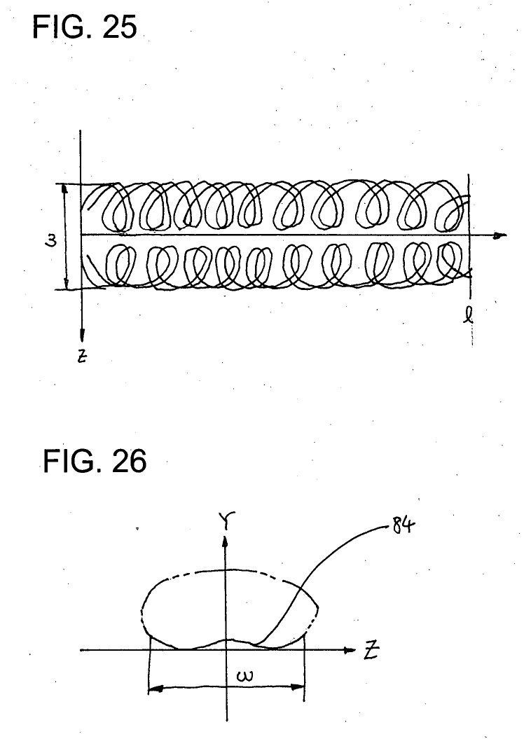

FIG. 19 shows that the movement of two massage bumps 74 follow the same width curve. Alternatively, as shown in FIGS. 24 and 25, the width curves followed by two longitudinally adjacent massage bumps are spaced by the distance between the two longitudinally adjacent massage bumps.

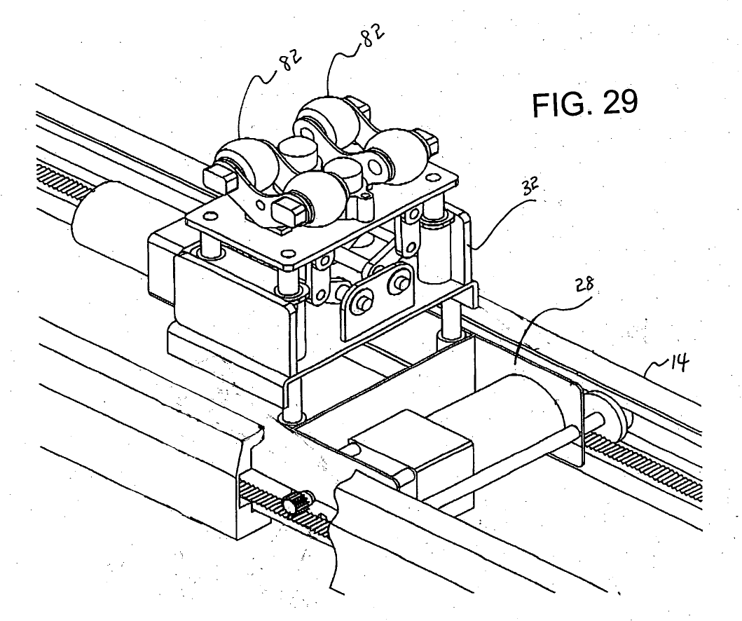

FIG. 29 shows an example of the massaging apparatus 10. The first axis actuator 28 is movable longitudinally along the platform 14, and the second axis actuator 32 move the massage bumps 82 up and down. The movable massage bumps 82 are wheels.

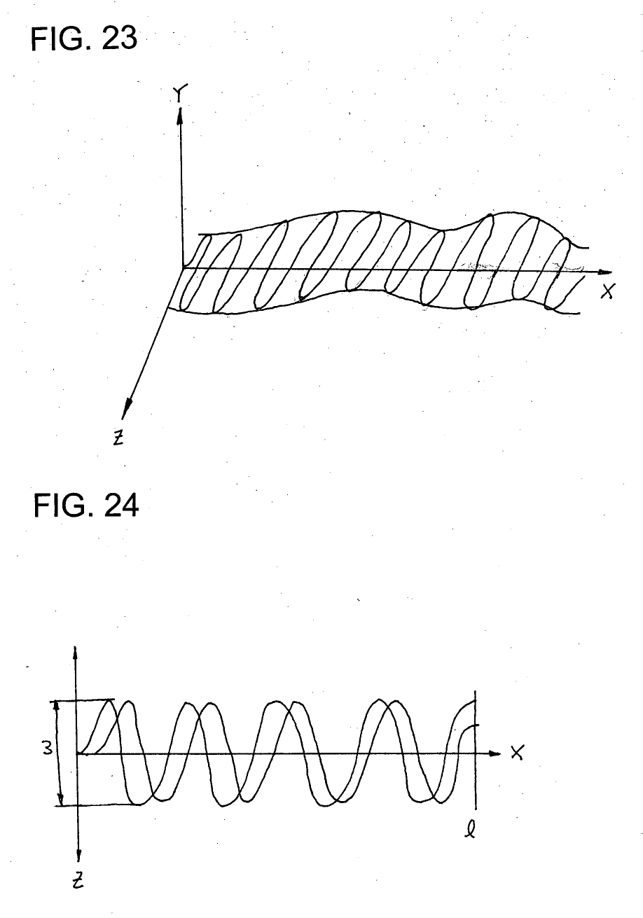

In FIG. 10, the movable massage bumps 78 are spheres. FIG. 23 shows that the height curve and the width curve form a massage surface which the pressure applying member 20 follows.

FIG. 26 shows that the width curve 84 follows the body contour of the patient.

The body contour of the patient is measured by measuring the second axis Y coordinate of the pressure applying member 20 while the pressure applying member 20 is moved along the third axis Z at a constant speed at a given first axis X coordinate. The pressure applying member 20 is moved toward the patient in the direction of the second axis Y until the pressure applied on the patient by the pressure applying member 20 reaches a threshold. A curve formed by the measured second axis Y coordinates and the corresponding third axis Z coordinates is memorized in the microprocessor 26.

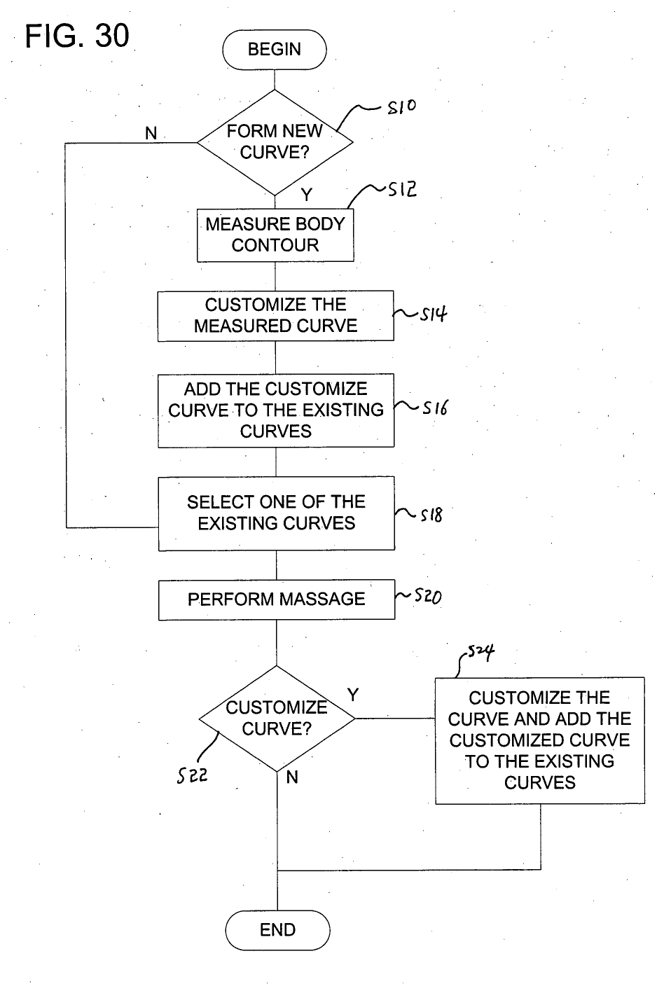

As shown in FIG. 30, a method for massaging the body of a patient according to the present invention starts with a step S10 of asking the patient or the user whether to form a new curve.

If the answer is yes in step S10, the process goes to step S12, in which the body contour of the patient is measured. Then the process goes to step S14, in which the user can customize the measured curve. Then the process goes to step S16, in which the customized curve is memorized in the microprocessor 26. That is, the customized curve is added to the existing curves stored in the microprocessor 26. Then the process goes to step S18, in which the user is asked to select a massaging curve.

If the answer is no in step S10, the process goes directly to step-S18.

When a massaging curve is selected in step S18, the process goes to step S20, in which the pressure applying member 20 is moved along the longitudinal stroke. Specifically, the step S20 includes moving the pressure applying member 20 forward from the first end 16 to the second end 18, moving the pressure applying member 20 backward from the second end 18 to the first end 16, and repeating the forward moving step and the backward moving step.

Then in step S22, the user is asked whether to customize the massaging curve performed in step S20, and if the answer is yes, the curve is customized by the user in step S24, and stored in the microprocessor 26.

During step S22, the movement of the pressure applying member 20 in the second axis Y direction is stopped when the pressure applied by the pressure applying member 20 reaches a massage pressure threshold. The massage pressure threshold is adjustable by the user. In this way, excess displacement of the pressure applying member, which might cause pain to the user, is prevented, and the user can adjust the intensity of massaging.

In step S12, the second axis Y coordinate of the pressure applying member 20 is measured while the pressure applying member 20 is moved along the first axis X at a constant speed. The pressure applying member is moved toward the patient in the direction of the second axis Y until the pressure applied on the patient by the pressure applying member reaches a threshold. The patient can adjust the threshold.

In step S16, the curve formed by the measured second axis Y coordinates and the corresponding first axis X coordinates is memorized.

In step S18, the curve includes the memorized curve in step S16.

The temperature of the pressure applying member is controlled as a third function of the first axis coordinate in step S20.

A massage therapy cycle consists of a plurality of height curves. Initially, the height curve is the curve following the backside contour of the patient for a few curves of the forward and backward moving steps, and then the height curve includes acupressure sections. The acupressure sections include linear acupressure movement, or convex acupressure movement or both. The patient can add or remove acupressure sections along the first axis X in step S24.

Although the invention has been described in considerable detail, other versions are possible by converting the aforementioned construction. Therefore, the scope of the invention shall not be limited by the specification specified above.

What is claimed is:

1. A method for massaging the body of a patient, who is resting on an upper surface portion of a platform,
wherein the upper surface portion comprises a first end and a second end, the method comprising a step of moving a pressure applying member between the first end to the second end for a predetermined longitudinal stroke,
wherein the step of moving the pressure applying member comprises:
a) moving the pressure applying member forward from the first end to the second end;
b) moving the pressure applying member backward from the second end to the first end;
c) repeating the forward moving step and the backward moving step;
wherein the movement of the pressure applying member follows a predetermined height curve in a plane defined by a first axis that is parallel to the upper surface portion and longitudinal to the platform and a second axis that is perpendicular to the first axis and to the upper surface portion, and
wherein the first axis coordinate of the height curve is defined by a first function of time, and the second axis coordinate of the height curve is defined by a second function of the first axis coordinate.

2. The method of claim 1 wherein the height curve follows the backside contour of the patient.

3. The method of claim 2 wherein the height curve comprises a plurality of square curves at predetermined first axis coordinates.

4. The method of claim 3 wherein the movement of the pressure applying member along each of the square curves is repeated for a predetermined number of times.

5. The method of claim 3 wherein the starting point of each of the square waves shifts for a predetermined distance along the first axis.

6. The method of claim 2 wherein the height curve includes a plurality of convex portions at predetermined first axis coordinates.

7. The method of claim 6 wherein the movement of the pressure applying member along each of the convex portions is repeated for a predetermined number of times.

8. The method of claim 6 wherein the starting point of each of the convex portions shifts for a predetermined distance along the first axis.

9. The method of claim 2 wherein the height curve comprises a plurality of square curves and a plurality of convex portions at predetermined first axis coordinates.

10. The method of claim 2 wherein the height curve is divided into a plurality of discrete sections, and the pressure applying member applies pressure to the patient for selected discrete sections.

11. The method of claim 2 wherein the second axis coordinate of the height curve has a constant value, wherein the constant value is sufficiently small so that the pressure applying member does not apply pressure to the patient.

12. The method of claim 2 wherein during the step of moving the pressure applying member, the movement of the pressure applying member in the second axis direction is stopped when the pressure applied by the pressure applying member reaches a massage pressure threshold.

13. The method of claim 12 wherein the massage pressure threshold is adjustable.

14. The method of claim 2 wherein the reference point of the second axis coordinate of the height curve is adjustable whereby the pressure applied by the pressure applying member is adjustable.

15. The method of claim 1 wherein the longitudinal stroke is adjustable for a different height of the patient.

16. The method of claim 15 wherein the height curve is adjusted proportional to the longitudinal stroke.

17. The method of claim 1 wherein the platform makes an angle with a horizontal surface, and the angle is adjustable.

18. The method of claim 1 further comprising a step of measuring body contour before the step of moving the pressure applying member along the height curve, wherein the measuring step comprises measuring the second axis coordinate of the pressure applying member while the pressure applying member is moved along the first axis at a constant speed, wherein during the measuring step, the pressure applying member is moved toward the patient in the direction of the second axis until the pressure applied on the patient by the pressure applying member reaches a threshold.

19. The method of claim 18 wherein in the measuring step, a curve formed by the measured second axis coordinates and the corresponding first axis coordinates is memorized.

20. The method of claim 19 wherein in the moving step, the height curve includes the memorized curve.

21. The method of claim 18 wherein the patient can adjust the threshold in the measuring step.

22. The method of claim 1 wherein the pressure applying member has a heating member, wherein the temperature of the heating member is controlled as a third function of the first axis coordinate in the moving step.

23. The method of claim 1 wherein during the step of moving the pressure applying member, the movement of the pressure applying member follows a predetermined width curve in a plane defined by the second axis and a third axis that is perpendicular to the first axis and the second axis, and wherein the third axis coordinate of the predetermined width curve is defined by a fourth function of the first axis coordinate.

24. The method of claim 23 wherein the pressure applying member comprises one or more movable massage bumps that protrude toward the patient, and the movement of the massage bumps follow the predetermined width curve.

25. The method of claim 24 wherein the pressure applying member further comprises one or more fixed massage bumps.

26. The method of claim 24 wherein the width curve is a sine wave.

27. The method of claim 24 wherein the width curve has a shape of a two-dimensional coil.

28. The method of claim 24 wherein the maximum width of the width curve is adjustable.

29. The method of claim 24 wherein the massage bumps are positioned symmetrical to the center of the pressure applying member, wherein the movement of the massage bumps forms two width curves that are parallel to each other.

30. The method of claim 29 wherein the width curves are sine waves.

31. The method of claim 29 wherein the width curves have a shape of a two-dimensional coil.

32. The method of claim 24 wherein the movement of the massage bumps follow the same width curve.

33. The method of claim 24 wherein the width curves followed by two longitudinally adjacent massage bumps among the massage bumps are spaced by the distance between the two longitudinally adjacent massage bumps.

34. The method of claim 24 wherein body contour of the patient is measured by measuring the second axis coordinate of the pressure applying member while the pressure applying member is moved along the third axis at a constant speed at a given first axis coordinate, wherein the pressure applying member is moved toward the patient in the direction of the second axis until the pressure applied on the patient by the pressure applying member reaches a threshold.

35. The method of claim 34 wherein a curve formed by the measured second axis coordinates and the corresponding third axis coordinates is memorized.

36. The method of claim 23 wherein the height curve and the width curve form a massage surface which the pressure applying member follows.

37. The method of claim 23 wherein the width curve follows the body contour of the patient.

38. The method of claim 1 wherein the height curve is the curve following the backside contour of the patient for initial predetermined number of cycles of the forward and backward moving steps, and then the height curve includes acupressure sections.

39. The method of claim 38 wherein the acupressure sections include linear acupressure movement, or convex acupressure movement or both.

40. The method of claim 39 wherein the patient can add or remove acupressure sections along the first axis.

41. An apparatus for massaging the body of a patient, who is resting on a upper surface portion of a platform, wherein the upper surface portion comprises a first end and a second end, the apparatus comprising:
a) a pressure applying member that is movable between the first end and the second end for a predetermined longitudinal stroke along a first axis that is parallel to the upper surface portion and longitudinal to the platform and a second axis that is perpendicular to the first axis and to the upper surface portion;
b) a first axis controller that controls movement of the pressure applying member along the first axis; and
c) a second axis controller that controls movement of the pressure applying member along the second axis;
wherein the movement of the pressure applying member follows a predetermined height curve in a plane defined by the first axis and the second axis, wherein the first axis coordinate of the height curve is defined by a first function of time, and the second axis coordinate of the height curve is defined by a second function of the first axis coordinate.

42. The apparatus of claim 41 further comprising a microprocessor that is connected to the first axis controller and the second axis controller, wherein the microprocessor stores a plurality of height curves, and wherein the first axis controller and the second axis controller control the movement of the pressure applying member following the height curve selected by the patient.

43. The apparatus of claim 42 wherein the first axis controller comprises a first axis actuator and a first axis displacement sensor, wherein the first axis actuator moves the pressure applying member along the first axis, and the first axis displacement sensor measures the displacement of the pressure applying member along the first axis, wherein the second axis controller comprises a second axis actuator and a second axis displacement sensor, wherein the second axis actuator moves the pressure applying member along the second axis, and the second axis displacement sensor measures the displacement of the pressure applying member along the second axis.

44. The apparatus of claim 42 wherein the second axis controller comprises a pressure sensor, wherein the pressure sensor measures the pressure applied to the patient by the pressure applying member.

45. The apparatus of claim 44 wherein during the movement of the pressure applying member, the movement of the pressure applying member in the second axis direction is stopped when the pressure applied by the pressure applying member reaches a massage pressure threshold.

46. The apparatus of claim 45 wherein the massage pressure threshold is adjustable.

47. The apparatus of claim 44 wherein body contour of the patient is measured by measuring the second axis coordinate of the pressure applying member while the pressure applying member is moved along the first axis at a constant speed, wherein the pressure applying member is moved toward the patient in the direction of the second axis until the pressure applied on the patient by the pressure applying member reaches a threshold.

48. The apparatus of claim 47 wherein a curve formed by the measured second axis coordinates and the corresponding first axis coordinates is memorized in the microprocessor.

49. The apparatus of claim 42 wherein the height curve follows the backside contour of the patient.

50. The apparatus of claim 42 wherein the height curve comprises a plurality of square curves at predetermined first axis coordinates.

51. The apparatus of claim 50 wherein the movement along each of the square curves is repeated for a predetermined number of times.

52. The apparatus of claim 50 wherein starting point of each of the square waves shifts along the first axis.

53. The apparatus of claim 42 wherein the height curve includes a plurality of convex portions at predetermined first axis coordinates.

54. The apparatus of claim 43 wherein the movement along each of the convex portions is repeated for a predetermined number of times.

55. The apparatus of claim 43 wherein starting point of each of the convex portions shifts along the first axis.

56. The apparatus of claim 42 wherein the height curve comprises a plurality of square curves and a plurality of convex portions at predetermined first axis coordinates.

57. The apparatus of claim 42 wherein the height curve is divided into a plurality of discrete sections, and the pressure applying member applies pressure to the patient for selected discrete sections.

58. The apparatus of claim 42 wherein the second axis coordinate of the height curve has a constant value, wherein the constant value is sufficiently small so that the pressure applying member does not apply pressure to the patient.

59. The apparatus of claim 42 wherein the reference point of the second axis coordinate of the height curve is adjustable whereby the pressure applied by the pressure applying member is adjustable.

60. The apparatus of claim 42 wherein the predetermined longitudinal stroke is adjustable for a different height of the patient.

61. The apparatus of claim 60 wherein the height curve is adjusted proportional to the longitudinal stroke.

62. The apparatus of claim 42 wherein the platform comprises an upper platform and a lower platform, wherein the upper platform supports the upper body of the patient, and the lower platform supports the lower body of the patient.

63. The apparatus of claim 62 wherein the upper platform makes an angle with a horizontal surface, and the angle is adjustable.

64. The apparatus of claim 42 wherein the pressure applying member comprises a heating member, wherein the temperature of the heating member is controlled as a third function of the first axis coordinate in the moving step.

65. The apparatus of claim 42 further comprising a third axis controller that controls movement of the pressure applying member along a third axis, wherein the third axis is perpendicular to the first axis and the second axis, wherein the movement of the pressure applying member follows a predetermined width curve in a plane defined by the second axis and the third axis, wherein the third axis coordinate of the width curve is defined by a fifth function of the first axis coordinate.

66. The apparatus of claim 65 wherein the microprocessor is connected to the third axis controller, wherein the microprocessor stores a plurality of width curves, and wherein the first axis controller and the third axis controller control the movement of the pressure applying member following the width curve selected by the patient.

67. The apparatus of claim 65 wherein the third axis controller comprises a third axis actuator and a third axis displacement sensor, wherein the third axis actuator moves the pressure applying member along the third axis, and the third axis displacement sensor measures the displacement of the pressure applying member along the third axis.

68. The apparatus of claim 67 wherein the third axis controller further comprises a temperature sensor, wherein the temperature sensor measures the temperature of the pressure applying member.

69. The apparatus of claim 65 wherein the width curve is a sine wave.

70. The apparatus of claim 65 wherein the width curve has a shape of a two-dimensional coil.

71. The apparatus of claim 65 wherein the maximum width of the width curve is adjustable.

72. The apparatus of claim 65 wherein the pressure applying member comprises one or more movable massage bumps that protrude toward the patient, and the movement of the massage bumps follow the predetermined width curve.

73. The apparatus of claim 72 wherein the pressure applying member further comprises one or more fixed massage bumps.

74. The apparatus of claim 72 wherein the massage bumps are positioned symmetrical to the center of the pressure applying member, wherein the movement of the massage bumps forms two width curves that are parallel to each other.

75. The apparatus of claim 72 wherein the movement of the massage bumps follow the same width curve.

76. The apparatus of claim 72 wherein the width curves followed by two longitudinally adjacent massage bumps among the massage bumps are spaced by the distance between the two longitudinally adjacent massage bumps.

77. The apparatus of claim 72 wherein the movable massage bumps are wheels.

78. The apparatus of claim 72 wherein the movable massage bumps are spheres.

79. The apparatus of claim 72 wherein the height curve and the width curve form a massage surface which the pressure applying member follows.

80. The apparatus of claim 75 wherein the width curve follows the body contour of the patient.

81. The apparatus of claim 75 wherein body contour of the patient is measured by measuring the second axis coordinate of the pressure applying member while the pressure applying member is moved along the third axis at a constant speed at a given first axis coordinate, wherein the pressure applying member is moved toward the patient in the direction of the second axis until the pressure applied on the patient by the pressure applying member reaches a threshold.

82. The apparatus of claim 71 wherein a curve formed by the measured second axis coordinates and the corresponding third axis coordinates is memorized in the microprocessor.

83. The apparatus of claim 65 wherein a remote controller is connected to the microprocessor.
